(19) United States
(12) Patent Application Publication
(10) Pub. No.: US 2015/0181258 A1
(43) Pub. Date: Jun. 25, 2015

(54) APPARATUS AND METHOD FOR PROVIDING MULTI-ANGLE VIEWING SERVICE

(71) Applicant: ELECTRONICS AND TELECOMMUNICATIONS RESEARCH INSTITUTE, Daejeon (KR)

(72) Inventors: Tae-Jung KIM, Daejeon (KR); Chang-Ki KIM, Daejeon (KR); Jae-Ho KIM, Nonsan-si (KR); Ju-Il JEON, Cheongju-si (KR); Jeong-Ju YOO, Daejeon (KR); Jin-Woo HONG, Daejeon (KR)

(73) Assignee: ELECTRONICS AND TELECOMMUNICATIONS RESEARCH INSTITUTE, Daejeon (KR)

(21) Appl. No.: 14/573,580

(22) Filed: Dec. 17, 2014

(30) Foreign Application Priority Data
Dec. 19, 2013 (KR) 10-2013-0159658

(51) Int. Cl. H04N 21/218; H04N 21/61; H04N 21/2381; H04N 21/242; H04N 21/234; H04N 21/2365; H04N 21/236

(52) U.S. Cl. CPC H04N 21/21805; H04N 21/2365; H04N 21/6125; H04N 21/23605; H04N 21/242; H04N 21/23406; H04N 21/2381

(57) ABSTRACT

An apparatus and method for providing a multi-angle viewing service, in which main broadcast content is transmitted to a main terminal and multi-angle content are transmitted to a personal terminal, are disclosed. The apparatus for providing a multi-angle viewing service includes an encoder unit configured to receive videos captured at a plurality of different angles from a plurality of cameras, and to generate a plurality of elementary streams, a broadcast transmission unit configured to transmit broadcast content generated based on the plurality of elementary streams through a broadcasting network, and a multi-angle streaming unit configured to generate a plurality of pieces of multi-angle content corresponding to the broadcast content based on the plurality of elementary streams, and to transmit one of the plurality of pieces of multi-angle content to a personal terminal through a network based on a request signal from the personal terminal.

### CROSS REFERENCE TO RELATED APPLICATION

This application claims the benefit of Korean Patent Application No. 10-2013-0159658, filed Dec. 19, 2013, which is hereby incorporated by reference in its entirety into this application.

### BACKGROUND

1. Technical Field

The present invention relates generally to an apparatus and method for providing a multi-angle viewing service and, more particularly, to an apparatus and method for providing a multi-angle viewing service, which provide viewers with multi-angle videos.

2. Description of the Related Art

A TV broadcasting program provides viewers with videos through one channel. At this time, in order to provide videos of sports, music programs, entertainment programs and the like, a broadcasting station arranges a plurality of cameras in a capturing site at various angles and captures videos. However, viewers can view only one video at an angle which is pre-determined by the broadcasting station from among a plurality of videos captured by a plurality of cameras. Therefore, there is a problem that viewers may not view videos taken from their personally desired camera angles.

In order to solve such problems, an IPTV system and the like provide a multi-angle broadcasting service. That is, the broadcasting station transmits videos captured by a plurality of cameras through different channels. Viewers can thus view videos of a desired angle by means of channel selection.

However, since a conventional multi-angle broadcasting service is provided to one terminal over a single network, it is a highly personalized content service. Furthermore, since a jitter time of about 1 second occurs in screen switching, there is a problematic interruption in both video and voice transmission. In connection with this, Korean Patent No. 10-1128848 discloses a technology related to “a server, a system, and a method for providing a multi-angle mobile broadcasting service.”

### SUMMARY

Accordingly, the present invention has been made keeping in mind the above problems occurring in the conventional art, and an object of the present invention is to provide an apparatus and method for providing a multi-angle viewing service, which transmit main broadcast content to a main terminal through a hybrid network and transmit multi-angle content to a personal terminal.

In accordance with an aspect of the present invention to accomplish the above object, there is provided an apparatus for providing a multi-angle viewing service, including an encoder unit for receiving videos captured at a plurality of different angles from a plurality of cameras, and generating a plurality of elementary streams; a broadcast transmission unit for transmitting broadcast content generated based on the plurality of elementary streams through a broadcasting network; and a multi-angle streaming unit for generating a plurality of pieces of multi-angle content corresponding to the broadcast content based on the plurality of elementary streams, and transmitting one of the plurality of pieces of multi-angle content to a personal terminal through a network in response to a request signal from the personal terminal.

The broadcast transmission unit may include a broadcasting Transport Stream (TS)-Muxer module for converting the plurality of elementary streams into a packetized elementary stream by packetizing the plurality of elementary streams, and for converting the packetized elementary stream into a transport stream; and a broadcasting network modulation module for modulating the transport stream into a broadcast signal, and transmitting the broadcast signal.

The broadcasting TS-Muxer module may insert metadata into a header of the transport stream, the metadata including an IP address for managing Internet content and a program ID.

The broadcast transmission unit may further include a synchronization buffer module for storing the transport stream converted by the broadcasting TS-Muxer module, and transmitting the stored transport stream to the broadcasting network modulation module after a delay time has elapsed.

The broadcast transmission unit may further include an encoder clock module for generating a program clock reference for synchronization of the broadcast content and multi-angle content, and transmitting the program clock reference to the multi-angle streaming unit.

The multi-angle streaming unit may include a multi-angle TS Muxer module for converting the plurality of elementary streams into a plurality of transport streams; a MPEG-2 TS segmenter module for generating segmented transfer streams by segmenting the transport streams converted by the multi-angle TS Muxer module into a preset size; an expansion media presentation description (MPD) generation module for generating a media presentation description schema of multi-angle content based on segment information generated when the MPEG-2 TS segmenter module generates the segmented transfer streams; and a multi-angle content processing module for detecting multi-angle content corresponding to broadcast content based on the request signal from the personal terminal and the media presentation description schema, and for transmitting the multi-angle content to the personal terminal through the network.

The multi-angle TS Muxer module may convert the plurality of elementary streams into the plurality of transport streams based on the program clock reference received from the broadcast transmission unit.

The MPEG-2 TS segmenter module may generate segment information including video codec information, a segment size, and a bit rate when the segmented transfer streams are generated.

The expansion MPD generation module may generate the media presentation description schema with a tree structure including a Period, a Group, a Representation, and a Segment with respect to one multi-angle content.

The multi-angle content processing module may detect the multi-angle content based on a program clock reference and the request signal received from the personal terminal and the media presentation description schema.

In accordance with another aspect of the present invention to accomplish the above object, there is provided a method of providing a multi-angle viewing service, including receiving, by an encoder unit, videos captured at a plurality of different angles from a plurality of cameras; encoding, by the encoder unit, the videos to generate a plurality of elementary streams; transmitting, by a broadcast transmission unit, broadcast content based on the plurality of elementary streams; generating, by a multi-angle streaming unit, multi-angle content based on the plurality of elementary streams; and transmitting, by the multi-angle streaming unit, multi-angle content to a personal terminal through a network based on a request signal received from the personal terminal.

Transmitting the broadcast content may include converting, by the broadcast transmission unit, the plurality of elementary streams into a packetized elementary stream by packetizing the plurality of elementary streams; converting, by the broadcast transmission unit, the packetized elementary stream into a transport stream; and modulating, by the broadcast transmission unit, the transport stream into a broadcast signal, and transmitting the broadcast signal.

Converting the packetized elementary stream into the transport stream may include inserting, by the broadcast transmission unit, metadata into a header of the transport stream, the metadata including an IP address for managing Internet content and a program ID.

Modulating the transport stream into the broadcast signal and transmitting the broadcast signal may include modulating, by the broadcast transmission unit, the transport stream into the broadcast signal and transmitting the broadcast signal after a delay time has elapsed.

Transmitting the broadcast content may include generating, by the broadcast transmission unit, a program clock reference for synchronization of the broadcast content and multi-angle content; and transmitting, by the broadcast transmission unit, the program clock reference together with the broadcast signal.

Generating the multi-angle content may include converting, by the multi-angle streaming unit, the plurality of elementary streams into transport streams; and segmenting, by the multi-angle streaming unit, the transport streams and generating segmented transfer streams.

Converting the plurality of elementary streams into the transport streams may include converting, by the multi-angle streaming unit, the plurality of elementary streams into the plurality of transport streams based on the program clock reference received from the broadcast transmission unit.

Converting the plurality of elementary streams into the transport streams may include generating, by the multi-angle streaming unit, segment information including video codec information, a segment size, and a bit rate.

Generating the multi-angle content may further include generating, by the multi-angle streaming unit, a media presentation description schema based on segment information.

Generating the media presentation description schema may include generating, by the multi-angle streaming unit, the media presentation description schema with a tree structure including a Period, a Group, a Representation, and a Segment with respect to one multi-angle content.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating the provision of a multi-angle viewing service by an apparatus for providing a multi-angle viewing service according to an embodiment of the present invention;

FIG. 2 is a block diagram illustrating the configuration of an apparatus for providing a multi-angle viewing service according to an embodiment of the present invention;

FIG. 3 is a block diagram illustrating a broadcast transmission unit of FIG. 2;

FIG. 4 is a block diagram illustrating a multi-angle streaming unit of FIG. 2;

FIG. 5 is a diagram illustrating an expansion MPD generation module of FIG. 4;

FIG. 6 is a flowchart illustrating a method for providing a multi-angle viewing service according to an embodiment of the present invention;

FIG. 7 is a flowchart illustrating a step of transmitting broadcast content of FIG. 6; and

FIG. 8 is a flowchart illustrating a step of generating multi-angle content of FIG. 6.

### DETAILED DESCRIPTION

Preferred embodiments of the present invention will be described in detail with reference to the attached drawings so as to describe in detail the present invention to such an extent that those skilled in the art can easily implement the technical spirit of the present invention. Reference now should be made to the drawings, in which the same reference numerals are used throughout the different drawings to designate the same or similar components. In the following description, detailed descriptions of related known elements or functions that may unnecessarily make the gist of the present invention obscure will be omitted.

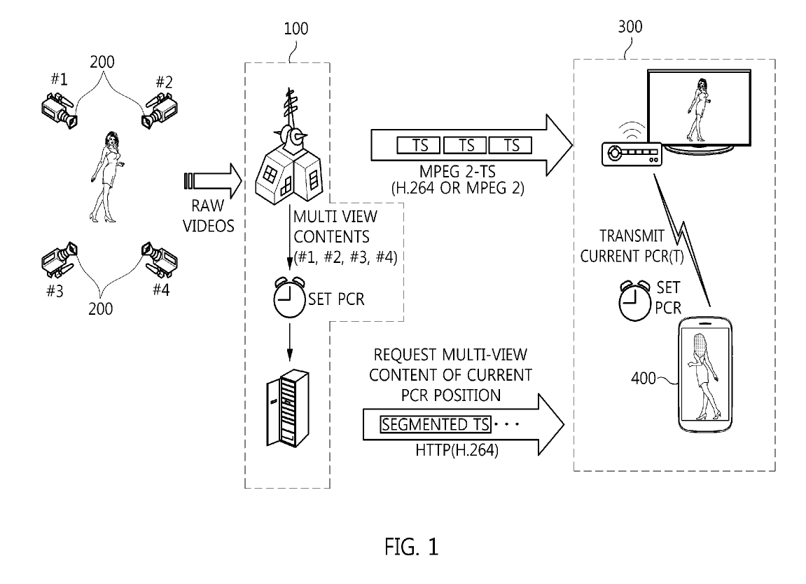

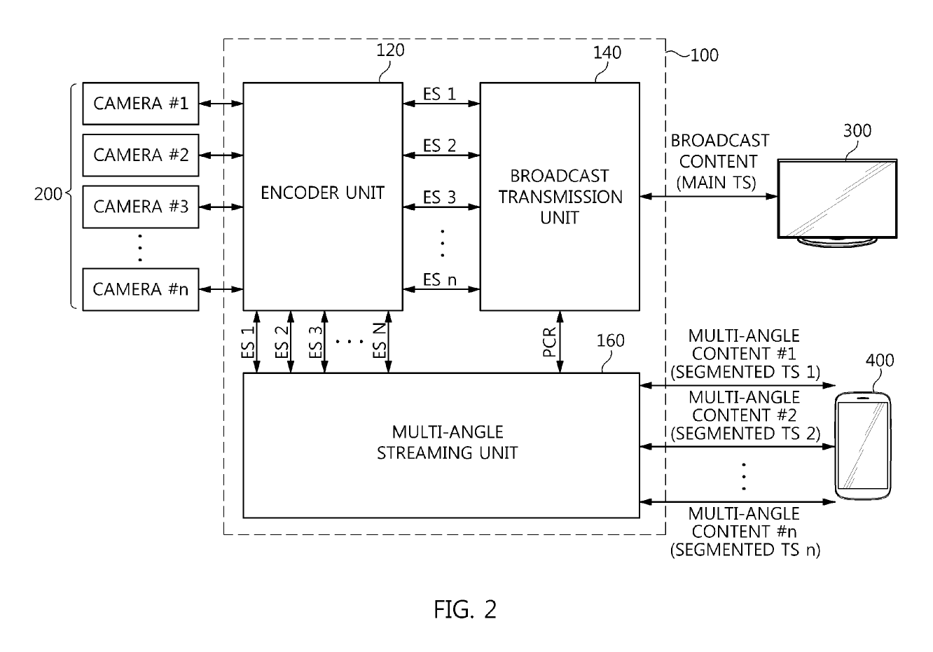

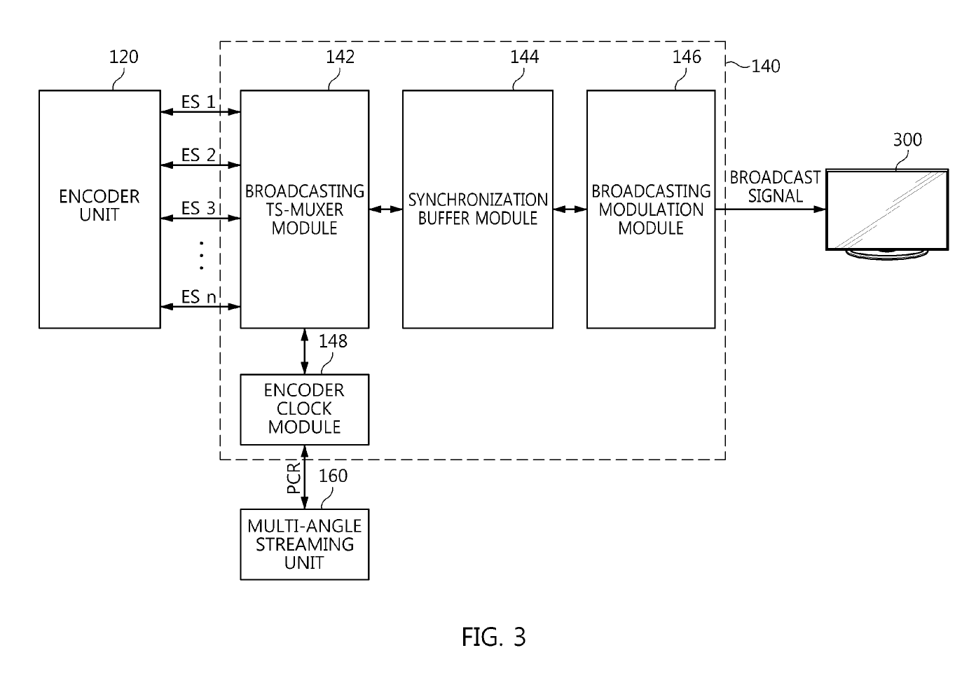

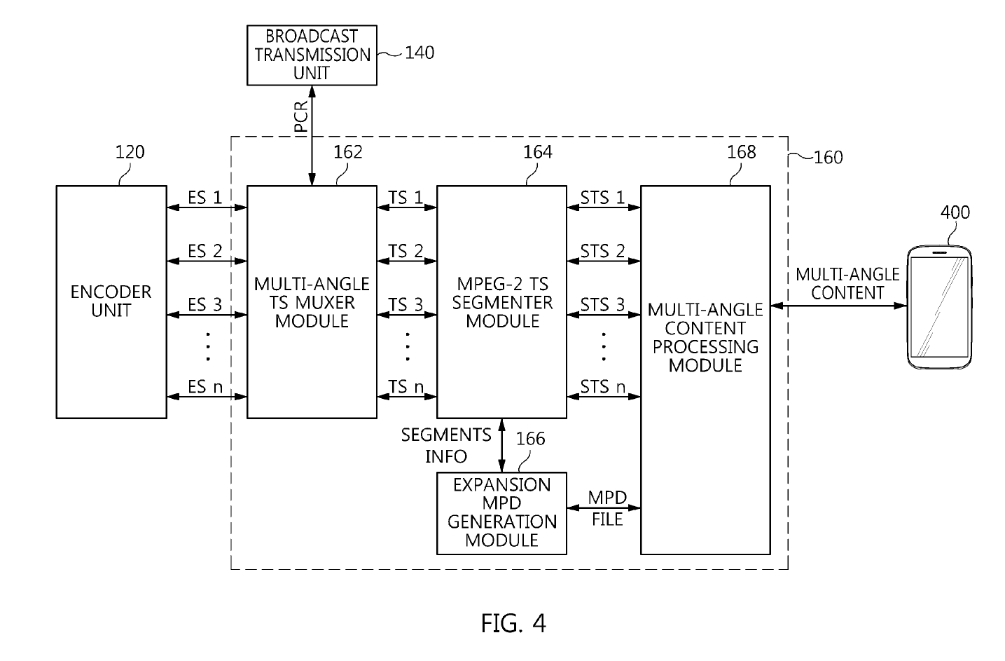

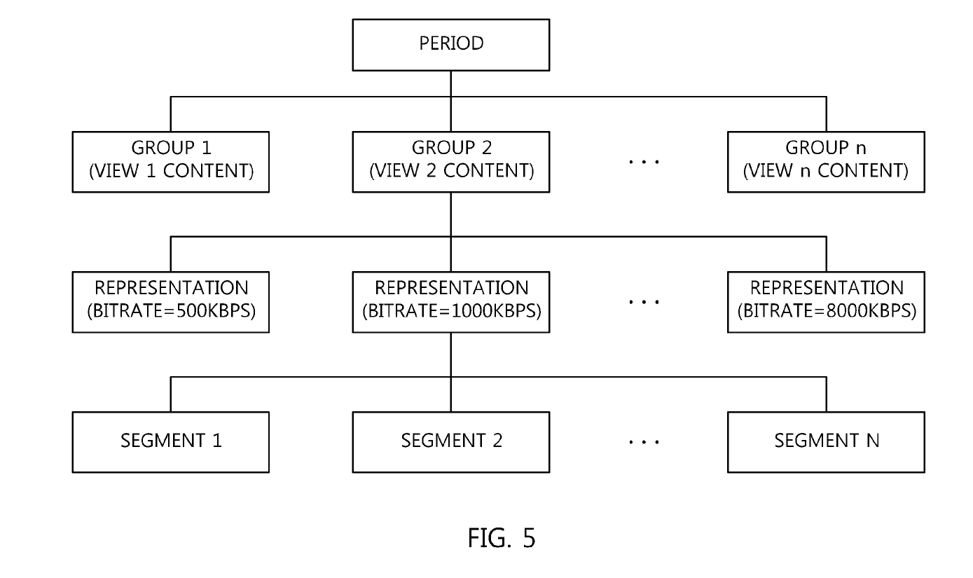

Hereinafter, an apparatus for providing a multi-angle viewing service according to an embodiment of the present invention will be described in detail with reference to the accompanying drawings. FIG. 1 is a schematic diagram illustrating the providing of a multi-angle viewing service of an apparatus for providing a multi-angle viewing service according to an embodiment of the present invention. FIG. 2 is a block diagram illustrating the configuration of the apparatus for providing a multi-angle viewing service according to the embodiment of the present invention. FIG. 3 is a block diagram illustrating a broadcast transmission unit of FIG. 2, and FIG. 4 is a block diagram illustrating a multi-angle streaming unit of FIG. 2. FIG. 5 is a diagram illustrating an expansion media presentation description (MPD) generation module of FIG. 4.

Referring to FIG. 1, the apparatus 100 for providing a multi-angle viewing service receives raw videos of multi-angle videos captured by a plurality of cameras 200. The apparatus 100 for providing a multi-angle viewing service selects one of the multi-angle videos and generates broadcast content (e.g., MPEG 2-TS (H.264 or MPEG 2)). The apparatus 100 for providing a multi-angle viewing service transmits the generated broadcast content to a main terminal 300 of a viewer through a broadcasting network. At this time, the apparatus 100 for providing a multi-angle viewing service transmits synchronization information (that is, a program clock reference (PCR)) for a multi-angle viewing service, together with the broadcast content, to the main terminal 300. At this time, for synchronization of the broadcast content (that is, content transmitted through the broadcasting network) and multi-angle content (that is, content transmitted through an Internet network or a mobile network), the apparatus 100 for providing a multi-angle viewing service synchronizes the two types of content with each other using one clock generator.

The viewer transmits the synchronization information, which is received from the main terminal 300, to the apparatus 100 for providing a multi-angle viewing service through a user terminal in order to utilize the multi-angle viewing service. Accordingly, based on the synchronization information, the apparatus 100 for providing a multi-angle viewing service converts a multi-angle video selected by a user into multi-angle content (e.g., H.264) and transmits the multi-angle content to the user terminal through a network (e.g., the Internet, a mobile communication network and the like).

As described above, the apparatus 100 for providing a multi-angle viewing service transmits main broadcast content to the main terminal 300 through a hybrid network such as a broadcasting network, the Internet, or a mobile network, and transmits multi-angle content to a personal terminal 400.

To this end, referring to FIG. 2, the apparatus 100 for providing a multi-angle viewing service includes an encoder unit 120, a broadcast transmission unit 140, and a multi-angle streaming unit 160.

The encoder unit 120 collects and encodes videos captured in a broadcasting station. That is, the encoder unit 120 receives the videos captured using the plurality of cameras 200 in the broadcasting station. At this time, the encoder unit 120 receives unprocessed raw videos from the plurality of cameras 200. The encoder unit 120 encodes respective videos and generates elementary streams (ESs). The encoder unit 120 transmits the generated elementary streams to the broadcast transmission unit 140 and the multi-angle streaming unit 160.

The broadcast transmission unit 140 selects one of the elementary streams (ESs) received from the encoder unit 120 and sets the selected one as broadcast content. The broadcast transmission unit 140 transmits the set broadcast content to the main terminal 300 of the viewer through the broadcasting network. That is, the broadcast transmission unit 140 functions to packetize N pieces of encoded content into a MPEG-2 transport stream as one broadcasting program and to report the multi-angle viewing service, while performing buffer management for transmission synchronization with a multi-angle viewing streaming server. To this end, referring to FIG. 3, the broadcast transmission unit 140 includes a broadcasting TS-Muxer module 142, a synchronization buffer module 144, a broadcasting network modulation module 146, and an encoder clock module 148.

The broadcasting TS-Muxer module 142 converts the plurality of elementary streams (ESs) into a packetized elementary stream (PES) by packetizing the plurality of elementary streams (ESs). The broadcasting TS-Muxer module 142 converts the converted packetized elementary stream into a transport stream (TS). At this time, the broadcasting TS-Muxer module 142 inserts metadata into the transport stream. The metadata includes an IP address for manages Internet content, and a program ID, and is inserted into a header of the transport stream. The broadcasting TS-Muxer module 142 transmits the converted transport stream to the synchronization buffer module 144.

The synchronization buffer module 144 transmits the broadcast content (that is, the transport stream) after a delay time has elapsed so as to perform synchronization with the multi-video content of the multi-angle streaming unit 160. The delay time is a value preset and fixed in the apparatus and may be differently set according to the performance of the apparatus. The delay time is set as a fixed delay time corresponding to a time taken for the multi-angle streaming unit 160 to receive the elementary streams, to convert the elementary streams into a transport stream, and to complete segmentation.

The broadcasting network modulation module 146 modulates the broadcast content, which has been delayed and transmitted by the synchronization buffer module 144, into a signal for cable broadcasting or terrestrial broadcasting. At this time, the broadcasting network modulation module 146 modulates and transmits the broadcast content in the same manner as that of the existing TV transmission system.

The encoder clock module 148 generates a clock for synchronization of the broadcast content and the multi-angle content. That is, the encoder clock module 148 generates the program clock reference (PCR) for the purpose of the synchronization of the broadcast content and the multi-angle content, and transmits the program clock reference (PCR) to the multi-angle streaming unit 160. At this time, the encoder clock module 148 generates the clock in units of about 27 MHz.

The multi-angle streaming unit 160 sets the elementary streams (ESs), which have been received from the encoder unit 120, as respective pieces of multi-angle content. The multi-angle streaming unit 160 transmits multi-angle content requested by the personal terminal 400 of a viewer to the personal terminal 400 through the network (that is, the Internet or the mobile network). The multi-angle streaming unit 160 converts a plurality of pieces of multi-angle content into a video compressed at a minimum bit rate, minimally transmits the video, and channel-adaptively transmits a view (that is, an angle) selected by a user. To this end, referring to FIG. 4, the multi-angle streaming unit 160 includes a multi-angle TS Muxer module 162, a MPEG-2 TS segmenter module 164, an expansion MPD generation module 166, and a multi-angle content processing module 168.

The multi-angle TS Muxer module 162 converts the plurality of elementary streams (ESs) received from the encoder unit 120 into a plurality of transport streams (TSs). At this time, based on the program clock reference received from the broadcast transmission unit 140, the multi-angle TS Muxer module 162 converts the elementary streams (ESs) into the transport streams (TSs). The multi-angle TS Muxer module 162 transmits the plurality of converted transport streams (TSs) to the MPEG-2 TS segmenter module 164.

The MPEG-2 TS segmenter module 164 segments the plurality of transport streams (TSs) received from the multi-angle TS Muxer module 162 at a preset size, thereby generating segmented transfer streams (STSs). That is, in order to stream the transport streams corresponding to respective angles through the network (that is, the Internet network, the mobile network and the like), the MPEG-2 TS segmenter module 164 segments the transport streams into streams of the preset size. At this time, the MPEG-2 TS segmenter module 164 segments the transport streams (TSs) in units of instantaneous decoding refresh (IDR) for the purpose of a smooth switching function. Of course, the MPEG-2 TS segmenter module 164 may also segment the transport streams at a minimum size required for streaming in the network or a size preset by a provider. The MPEG-2 TS segmenter module 164 transmits the generated segmented transfer streams to the multi-angle content processing module 168.

The MPEG-2 TS segmenter module 164 transmits segment information required in a segmentation process of the transport streams to the expansion MPD generation module 166. That is, the MPEG-2 TS segmenter module 164 transmits the segment information including video codec information, a segment size, a bit rate and the like to the expansion MPD generation module 166.

Based on the segment information received from the MPEG-2 TS segmenter module 164, the expansion MPD generation module 166 generates a media presentation description (MPD) schema (hereinafter, referred to as a “MPD schema”) of the multi-angle content. That is, for the service of the multi-angle content, the expansion MPD generation module 166 generates the MPD schema that is supplementary data. The expansion MPD generation module 166 transmits the generated MPD schema to the multi-angle content processing module 168. At this time, referring to FIG. 4, the expansion MPD generation module 166 generates the MPD schema with a tree structure including a Period, a Group, a Representation, and a Segment with respect to one video (that is, the multi-angle content). That is, one Period exists with respect to one video. The Period includes Groups corresponding to the number of pieces of multi-angle content included in the video. Each Group includes a plurality of Representations, and one Representation includes a plurality of Segments.

The multi-angle content processing module 168 transmits the multi-angle content requested by the personal terminal 400 of a viewer to the personal terminal 400 through the network. That is, the personal terminal 400 receives from the main terminal 300 a program clock reference of broadcast content which is being currently broadcasted. The personal terminal 400 transmits a multi-angle content request signal (that is, including multi-angle content desired to be viewed), together with the received program clock reference, to the multi-angle content processing module 168. Accordingly, the multi-angle content processing module 168 transmits the multi-angle content to the personal terminal 400 through the network based on the MPD schema received from the expansion MPD generation module 166 and the program clock reference and the request signal received from the personal terminal 400.

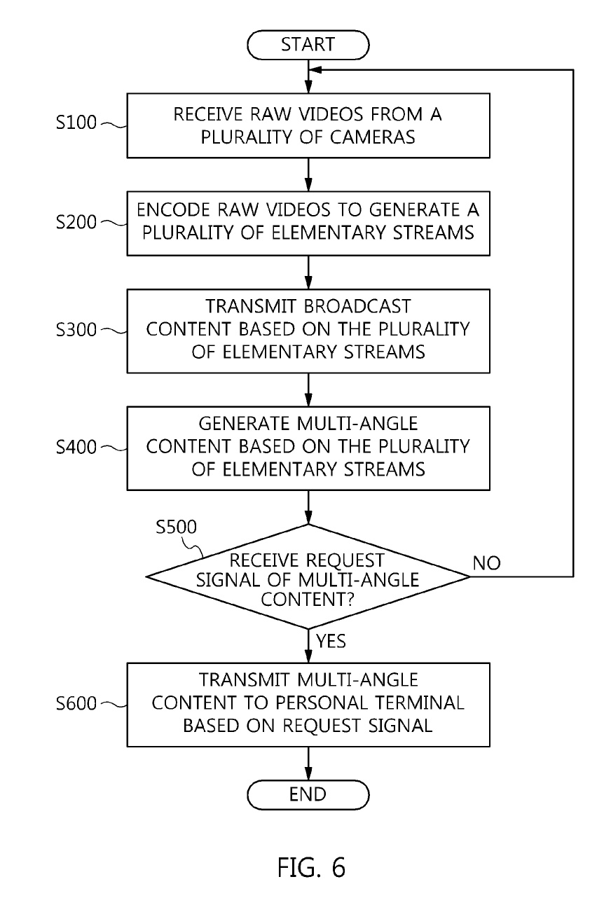

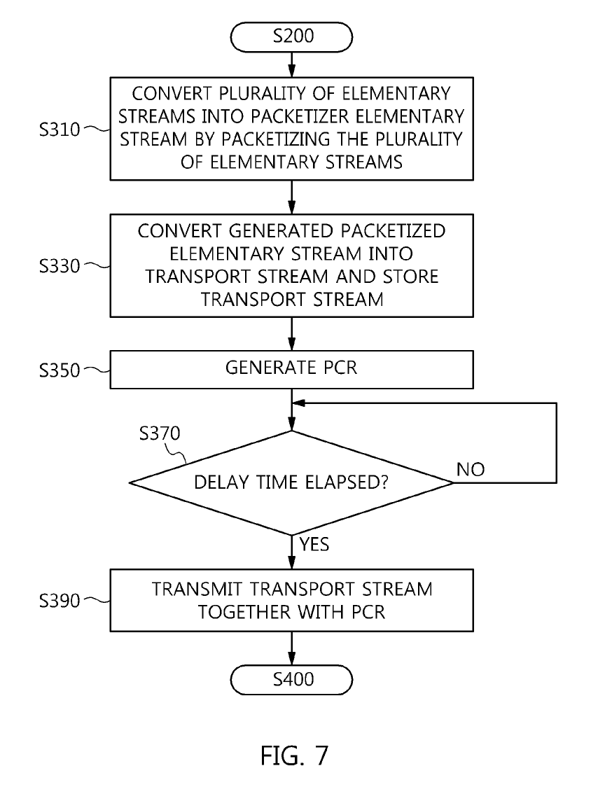

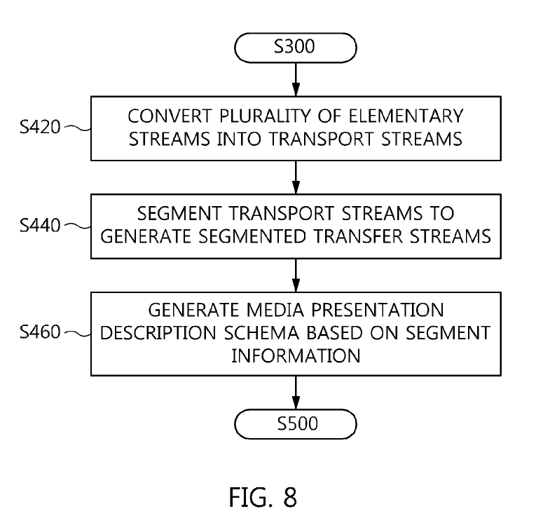

Hereinafter, the method for providing a multi-angle viewing service according to the embodiment of the present invention will be described in detail with reference to the accompanying drawings. FIG. 6 is a flowchart showing the method for providing a multi-angle viewing service according to the embodiment of the present invention. FIG. 7 is a flowchart showing the broadcast content transmission step of FIG. 6, and FIG. 8 is a flowchart showing the multi-angle content generation step of FIG. 6.

The encoder unit 120 receives raw videos captured by the plurality of cameras 200 at step S100. That is, the encoder unit 120 receives videos captured at a plurality of different angles from the cameras 200 arranged in a broadcasting station. At this time, the encoder unit 120 receives unprocessed raw videos from the respective cameras 200.

The encoder unit 120 encodes the received raw videos to generate a plurality of elementary streams (ESs) at step S200. The encoder unit 120 transmits the generated elementary streams to the broadcast transmission unit 140 and the multi-angle streaming unit 160.

The broadcast transmission unit 140 transmits broadcast content based on the plurality of elementary streams (ESs) at step S300. At this time, the broadcast transmission unit 140 selects one from the elementary streams (ESs) received from the encoder unit 120 and sets the selected one as broadcast content. The broadcast transmission unit 140 transmits the set broadcast content to the main terminal 300 of a viewer through the broadcasting network. This will be described in detail with referenced to FIG. 7.

The broadcast transmission unit 140 converts the plurality of elementary streams into a packetized elementary stream by packetizing the plurality of elementary streams at step S310.

The broadcast transmission unit 140 converts the generated packetized elementary stream into a transport stream, and stores the transport stream at step S330. That is, the broadcast transmission unit 140 converts the packetized elementary stream into the transport stream. The broadcast transmission unit 140 inserts metadata, which includes an IP address for managing Internet content and a program ID, into a header of the transport stream. The broadcast transmission unit 140 stores the transport stream, into which the metadata has been inserted, in a buffer.

The broadcast transmission unit 140 generates a program clock reference at step S350. That is, the broadcast transmission unit 140 generates the program clock reference that is a clock for synchronization of multi-angle content.

If a delay time has elapsed (Yes at step S370), the broadcast transmission unit 140 transmits the transport stream together with the program clock reference at step S390. That is, the broadcast transmission unit 140 delays the delay time for the purpose of the synchronization of the broadcast content and the multi-angle content, and transmits the broadcast content. The delay time is a value preset and fixed in the apparatus and may be differently set according to the performance of the apparatus. The broadcast transmission unit 140 modulates the broadcast content (that is, the transport stream) into a broadcast signal for cable broadcasting or terrestrial broadcasting, and transmits the broadcast signal.

The multi-angle streaming unit 160 generates the multi-angle content based on the plurality of elementary streams at step S400. This will be described in detail with referenced to FIG. 8.

The multi-angle streaming unit 160 converts the plurality of elementary streams into transport streams at step S420. That is, based on the program clock reference received from the broadcast transmission unit 140, the multi-angle streaming unit 160 converts the elementary streams (ESs) into the transport streams (TSs).

The multi-angle streaming unit 160 segments the transport streams to generate segmented transfer streams at step S440.

The multi-angle streaming unit 160 segments the transport streams (TSs) at a preset size to generate the segmented transfer streams (STSs). That is, in order to stream the transport streams corresponding to respective angles through the network (that is, the Internet network, the mobile network and the like), the multi-angle streaming unit 160 segments the transport streams into streams of the preset size. At this time, the multi-angle streaming unit 160 segments the transport streams (TSs) in units of instantaneous decoding refresh (IDR) for the purpose of a smooth switching function. Of course, the multi-angle streaming unit 160 may also segment the transport streams at a minimum size required for streaming in the network or a size preset by a provider.

Based on segment information, the multi-angle streaming unit 160 generates a media presentation description schema at step S460. That is, based on the segment information required in the segmentation process of the transport streams, the multi-angle streaming unit 160 generates the media presentation description schema. The segment information includes video codec information, a segment size, a bit rate and the like. The multi-angle streaming unit 160 generates the media presentation description schema with a tree structure including a Period, a Group, a Representation, and a Segment with respect to one video (that is, the multi-angle content).

When a request signal of the multi-angle content is received from the personal terminal 400 (Yes at step S500), the multi-angle streaming unit 160 transmits the multi-angle content to the personal terminal 400 based on the request signal at step S600. The personal terminal 400 receives a program clock reference of broadcast content being currently broadcasted from the main terminal 300. The personal terminal 400 transmits a multi-angle content request signal (that is, including multi-angle content desired to be viewed), together with the received program clock reference, to the multi-angle streaming unit 160. Accordingly, the multi-angle streaming unit 160 transmits the multi-angle content to the personal terminal 400 through the network based on the MPD schema and the program clock reference and the request signal received from the personal terminal 400.

As described above, according to the apparatus and the method for providing a multi-angle viewing service, main broadcast content is transmitted to the main terminal through the hybrid network and multi-angle content is transmitted to the personal terminal, so that it is possible to transmit broadcast content on a broadcast and to channel-adaptively view videos in multi-angle view through the Internet at a user's request.

Furthermore, according to the apparatus and the method for providing a multi-angle viewing service, the main broadcast content is transmitted to the main terminal through the hybrid network and the multi-angle content is transmitted to the personal terminal, so that it is possible to solve the jitter time problem with the conventional multi-angle service that occurs because respective views are transmitted from view selection times. That is, according to the apparatus and the method for providing a multi-angle viewing service, respective videos having a minimum bit rate are transmitted and only a view selected by a user is channel-adaptively transmitted, so that it is possible to seamlessly view videos without jitter time or video interruption.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for providing a multi-angle viewing service, comprising:
an encoder unit for receiving videos captured at a plurality of different angles from a plurality of cameras, and generating a plurality of elementary streams;
a broadcast transmission unit for transmitting broadcast content generated based on the plurality of elementary streams through a broadcasting network; and
a multi-angle streaming unit for generating a plurality of pieces of multi-angle content corresponding to the broadcast content based on the plurality of elementary streams, and transmitting one of the plurality of pieces of multi-angle content to a personal terminal through a network in response to a request signal from the personal terminal.

2. The apparatus of claim 1, wherein the broadcast transmission unit comprises:
a broadcasting Transport Stream (TS)-Muxer module for converting the plurality of elementary streams into a packetized elementary stream by packetizing the plurality of elementary streams, and for converting the packetized elementary stream into a transport stream; and
a broadcasting network modulation module for modulating the transport stream into a broadcast signal, and transmitting the broadcast signal.

3. The apparatus of claim 2, wherein the broadcasting TS-Muxer module inserts metadata into a header of the transport stream, the metadata including an IP address for managing Internet content and a program ID.

4. The apparatus of claim 2, wherein the broadcast transmission unit further comprises:
a synchronization buffer module for storing the transport stream converted by the broadcasting TS-Muxer module, and transmitting the stored transport stream to the broadcasting network modulation module after a delay time has elapsed.

5. The apparatus of claim 2, wherein the broadcast transmission unit further comprises:
an encoder clock module for generating a program clock reference for synchronization of the broadcast content and multi-angle content, and transmitting the program clock reference to the multi-angle streaming unit.

6. The apparatus of claim 1, wherein the multi-angle streaming unit comprises:
a multi-angle TS Muxer module for converting the plurality of elementary streams into a plurality of transport streams;
a MPEG-2 TS segmenter module for generating segmented transfer streams by segmenting the transport streams converted by the multi-angle TS Muxer module into a preset size;
an expansion media presentation description (MPD) generation module for generating a media presentation description schema of multi-angle content based on segment information generated when the MPEG-2 TS segmenter module generates the segmented transfer streams; and
a multi-angle content processing module for detecting multi-angle content corresponding to broadcast content based on the request signal from the personal terminal and the media presentation description schema, and for transmitting the multi-angle content to the personal terminal through the network.

7. The apparatus of claim 6, wherein the multi-angle TS Muxer module converts the plurality of elementary streams into the plurality of transport streams based on the program clock reference received from the broadcast transmission unit.

8. The apparatus of claim 6, wherein the MPEG-2 TS segmenter module generates segment information including video codec information, a segment size, and a bit rate when the segmented transfer streams are generated.

9. The apparatus of claim 6, wherein the expansion MPD generation module generates the media presentation description schema with a tree structure including a Period, a Group, a Representation, and a Segment with respect to one multi-angle content.

10. The apparatus of claim 6, wherein the multi-angle content processing module detects the multi-angle content based on a program clock reference and the request signal received from the personal terminal and the media presentation description schema.

11. A method of providing a multi-angle viewing service, comprising:
receiving, by an encoder unit, videos captured at a plurality of different angles from a plurality of cameras;
encoding, by the encoder unit, the videos to generate a plurality of elementary streams;
transmitting, by a broadcast transmission unit, broadcast content based on the plurality of elementary streams;
generating, by a multi-angle streaming unit, multi-angle content based on the plurality of elementary streams; and
transmitting, by the multi-angle streaming unit, multi-angle content to a personal terminal through a network based on a request signal received from the personal terminal.

12. The method of claim 11, wherein transmitting the broadcast content comprises:
converting, by the broadcast transmission unit, the plurality of elementary streams into a packetized elementary stream by packetizing the plurality of elementary streams;
converting, by the broadcast transmission unit, the packetized elementary stream into a transport stream; and
modulating, by the broadcast transmission unit, the transport stream into a broadcast signal, and transmitting the broadcast signal.

13. The method of claim 12, wherein converting the packetized elementary stream into the transport stream comprises inserting, by the broadcast transmission unit, metadata into a header of the transport stream, the metadata including an IP address for managing Internet content and a program ID.

14. The method of claim 12, wherein modulating the transport stream into the broadcast signal and transmitting the broadcast signal comprises modulating, by the broadcast transmission unit, the transport stream into the broadcast signal and transmitting the broadcast signal after a delay time has elapsed.

15. The method of claim 12, wherein transmitting the broadcast content comprises:
generating, by the broadcast transmission unit, a program clock reference for synchronization of the broadcast content and multi-angle content; and
transmitting, by the broadcast transmission unit, the program clock reference together with the broadcast signal.

16. The method of claim 11, wherein generating the multi-angle content comprises:
converting, by the multi-angle streaming unit, the plurality of elementary streams into transport streams; and
segmenting, by the multi-angle streaming unit, the transport streams and generating segmented transfer streams.

17. The method of claim 16, wherein converting the plurality of elementary streams into the transport streams comprises converting, by the multi-angle streaming unit, the plurality of elementary streams into the plurality of transport streams based on the program clock reference received from the broadcast transmission unit.

18. The method of claim 16, wherein converting the plurality of elementary streams into the transport streams comprises generating, by the multi-angle streaming unit, segment information including video codec information, a segment size, and a bit rate.

19. The method of claim 16, wherein generating the multi-angle content further comprises generating, by the multi-angle streaming unit, a media presentation description schema based on segment information.

20. The method of claim 19, wherein generating the media presentation description schema comprises generating, by the multi-angle streaming unit, the media presentation description schema with a tree structure including a Period, a Group, a Representation, and a Segment with respect to one multi-angle content.
